(19) United States
(12) Patent Application Publication
(10) Pub. No.: US 2007/0289072 A1
(43) Pub. Date: Dec. 20, 2007

(54) NEW ANIONIC COLORING AGENTS TO DYE LEATHER, PAPER, CARDBOARD AND TEXTILE SUBSTRATES: MIXTURES OF COLORING AGENTS INCLUDING THESE NEW PRODUCTS, AND SUBSTRATES DYED USING THE ABOVE COLORING AGENTS

(75) Inventor: Jorge Mazza, Buenos Aires (AR)

Correspondence Address: DARBY & DARBY P.C., P.O. BOX 770, Church Street Station, New York, NY, 10008-0770, US

(73) Assignee: VILMAX S.A.C.I.F.I.A., Buenos Aires (AR)

(21) Appl. No.: 11/748,371

(22) Filed: May 14, 2007

Related U.S. Application Data
(63) Continuation-in-part of application No. 10/881,342, filed on Jun. 30, 2004, now abandoned.
Application No. 10/881,342 is a continuation-in-part of application No. 10/023,962, filed on Dec. 18, 2001, now abandoned.

(30) Foreign Application Priority Data
Dec. 18, 2000 (AR) P 00 01 06734

(51) Int. Cl. C09B 49/00; C09B 56/00; C09B 56/10; C09B 56/12; C09B 56/14

(52) U.S. Cl. 8/652; 8/675; 8/696

(57) ABSTRACT

An anionic coloring agent according to the following formula: C_{A}—R_{SA}. C_{A} comprises at least a chromophore and R_{SA} is a spacer-arm with the chemical structure: —X—R-Z. X is a chemical bond, —S(O)ₙ, or —NR₁, wherein R₁ is hydrogen or a C₁-C₁₀ alkyl group; R is a C₁-C₁₀ alkylene group; Z is —NR₂R₃, wherein R₂ and R₃ are, independently hydrogen or a C₁-C₁₀ alkyl group. Alternatively, Z is —NR₄—(CH₂)ₘ—W, wherein R₄ is hydrogen, a hydroxy C₁-C₁₀ alkyl group, or C₁-C₁₀ alkyl group; m is an integer from 1 to 10; and W is —COOR₅, wherein R₅ is hydrogen, a C₁-C₁₀ alkyl group; or —CONR₆R₇. R₆ and R₇ are, independently, a hydrogen atom, a C₁-C₁₀ alkyl group, —SO₃H; —S—SO₃H; —CN: or SO₃R₈ wherein, R₈ is hydrogen, a C₁-C₁₀ alkyl group, or —S—SO₃R₉ group, wherein, R₉ is hydrogen atom, or a C₁-C₁₀ alkyl group; provided that when X is —NR₁, and Z is —NR₂R₃, then R₁, R₂ and R₃ cannot be simultaneously a hydrogen atom. The inclusion of spacer-arms in anionic coloring agents improves dye properties such as strength, tone and affinity.

### BACKGROUND OF THE INVENTION

Since the time when synthetic organic coloring agents were discovered at the end of the XIXth century, they have been developed surprisingly. It is estimated that today there are more than 10.000 coloring agents which are or else have been used for industrial applications. It is to be remembered that the main application of these products comprises coloring a number of substances and materials of different origin, which without said coloring would not have such a pleasant appearance.

The discovery of synthetic organic coloring agents, and in particular of those having bright tones and which are cheap, has brought about a real social revolution, improving color, the general aspect and the warmth of our environment. The world around us has changed for the better since the moment said agents appeared.

It should be observed that, before synthetic organic agents were discovered, bright colors were obtained from very high cost natural colors, whose production was, moreover, highly polluting. Due to their high cost, applications used to be limited, and bright colors (bishop's purple, Tiro's purple) were then only an exception for grey and ocher, which were commonly found in daily life.

Synthetic organic colors are used to color a large number of substrates having different compositions: plastics, textile materials, paper, leather, paints, printing inks, etc.

Each substrate has a particular group of coloring agents. These, in turn, have either chemical groups or functions, which are responsible for the color, which are called “chromophores”. The most common ones have an azo, anthraquinone, formazane, dioxacine or phtlacianine structure, etc. According to the complete molecular structure of the coloring agent, and not only on the structure of the chromophore, coloring agents can be classified as direct, acid, reactive, disperse, and organic pigments.

As mentioned above, there are specific coloring groups for each substrate. Thus, for example, the best coloring agents to dye cotton fibers are totally different from those used to dye woolen fibers, or acetate or polyester fibers. And, of course, they are totally different from those used to color polyethylene, PVC or polyurethane films.

Another variable to be taken into account is the color desired. For each substrate, each different color derives from one or several chemical structures and chromophores which can be different from those that create other colors.

Consequently, there are hundreds of different possibilities which, in turn, justify the need for further and constant research in this field.

As time went by, coloring agents were improved in order to enhance their properties as regards applications on traditional substrates, and also to adapt them to the new substrates that appeared later on.

The hundreds of new patents that have been issued in the last decades are substantial evidence of permanent research and development in this field. Said patents are related, on the one hand, to the search for new chemical structures and families for new coloring agents, and also to the modification of the already existing structures, in order to enhance some of their properties.

The most important properties may vary according to the composition and structure of the substrate on which the coloring agents will be applied, but some of them, such as dye yield, easiness of application and different degrees of strength (under the effect of light, bleeding in different materials, etc.), are always fundamental.

All these properties are related, in one way or another, to one fundamental property: the degree of fixation of the coloring agent on the substrate. This is vital, and there are dozens of patents whose main or only object comprises improving the fixation of a certain coloring agent on a given substrate.

For example, special reactive coloring agents to dye cotton are a particular case. A better fixation produces not only deeper shades of color, improves properties and degrees of strength, but also allows the cleaning of the coloring agent that has not been fixed. Moreover, it has an ecological advantage, that is, it generates effluents which are less colored.

The same applies in the case of special coloring agents for leather, with one more variable: the coloring agent penetrates more or less depending on the thickness of the leather to be dyed. In brief: variation in fixation degrees of the coloring agent on a certain substrate represents habitually a change in some of the properties of said coloring agent once it has been fixed.

Properties of interest are for example resistance to light, to water, to washing, to perspiration, to bleeding in different substances, etc.

The applicant has been working and doing research for many years in order to develop new synthetic coloring agents, among them, several specific anionic coloring agents for the purification of proteins, such as those described and claimed in U.S. Pat. No. 5,597,485 and U.S. Pat. No. 5,876,597. The chromophores of said coloring agents are azo, anthraquinone, formazane, dioxazine and/or phtalocianine.

A specific development related to both patents is the use of “spacer arms” in the structure of each coloring agent, in order to enhance the fixation and selectivity of each coloring agent on proteins, which is particularly interesting in absorption chromatography techniques and in dying processes in general.

Said spacer-arms are radicals or ordinary chemical groups bound to the molecules of coloring agents which modify some of their properties. One specific group of said spacer-arms are aliphatic chains, particularly hydrocarbonated chains including between 1 and 10 carbon atoms.

A novel aspect, also disclosed in said patents, is related to the discovery that the build-up of small quantities of coloring agents with spacer arms carried in coloring agents without said arms, improves the fixation of said carrier agents.

In this aspect, it is considered that the coloring agents modified by the inclusion of said spacer-arms, behave as catalysts for the fixation reactions of coloring agents which do not comprise said spacer arms.

In some embodiments, “spacer arms” correspond to either straight or branched C₁-C₁₀ alkylene chains, which can carry polar terminal groups, bound to the structure of the coloring agent.

### SUMMARY OF THE INVENTION

Anionic coloring agents are an object of this invention, and they are characterized in that they comprise at least one spacer arm bound to the structure of said coloring agents.

Therefore, this invention comprises anionic coloring agents comprising at least a spacer-arm in their chemical structure, wherein said anionic coloring agents have the following formula:
C_{A}—R_{SA}
wherein:
C_{A} is an anionic coloring agent comprising at least a chromophore group selected from the group consisting of azo, anthraquinone, formazane, dioxazine, phthalocyanine and/or sulphur; and
R_{SA} is said spacer-arm, which has the following chemical structure:
—X—R-Z
wherein,
X is a chemical bond or a group having the formula —S(O)ₙ, wherein n is 1 or 2; or a —NR₁-group, wherein R₁ is a hydrogen atom or a linear or branched C₁-C₁₀ alkyl group;
R is a linear or branched C₁-C₁₀ alkylene group;
Z is a —NR₂R₃ group, wherein, R₂ and R₃ are, independently, a hydrogen atom or a linear or branched C₁-C₁₀ alkyl group; or
Z is a —NR₄— (CH₂)ₘ—W group, wherein, R₄ is a hydrogen atom, or a linear or branched hydroxy C₁-C₁₀ alkyl group, or a linear or branched C₁-C₁₀ alkyl group;
m is an integer from 1 to 10;
and W is a —COOR₅ group, wherein, R₅ a hydrogen atom or a linear or branched C₁-C₁₀ alkyl group;
or W is a —CONR₆R₇ group wherein R₆ and R₇ are, independently, a hydrogen atom or a linear or branched C₁-C₁₀ alkyl group; or a —SO₃H; or —S—SO₃H; or —CN group; or a SO₃R₈, group, wherein, R₈ a hydrogen atom or a linear or branched C₁-C₁₀ alkyl group; or a —S—SO₃R₉ group, wherein, R₉ is a hydrogen atom, or a linear or branched C₁-C₁₀ alkyl group;
provided that when X is a —NR₁— group, and Z is a —NR₁, R₂ group, then R₁, R₂ and R₃ cannot be simultaneously a hydrogen atom.

Another object of this invention includes coloring compositions, which comprise at least one anionic coloring agent of the formula:
C_{A}—R_{SA}
wherein,
C_{A} and R_{SA} are as described above, in admixture with anionic coloring agents, which do not comprise spacer arms.

Another object of this invention includes the use of the anionic coloring agents as described above to dye cotton, nylon, wool, regenerated cellulose, leather, and cardboard and paper substrates.

Another object of present invention refers to cotton, nylon, wool, regenerated cellulose, leather, cardboard and paper substrates dyed with the anionic coloring agents as described above.

### DETAILED DESCRIPTION OF THE INVENTION

The present invention is based on the discovery that the introduction spacer arms in the molecular structure of anionic coloring agents as defined herein, leads to other anionic coloring agents which are different as regards some dyeing property/ies; or for example: strength (intensity or the coloring power, tone, affinity, the different resistances and fastnesses, previously mentioned, etc.).

Said replacement, in its broader aspect, constitutes a novel application for the modification of anionic coloring agents already revealed in the previous art as synthesis of new coloring agents. Therefore, the present invention allows the favorable modification of the properties of coloring agents already known, so as to produce and synthesize new anionic coloring agents.

The variation of properties is thought to be due to a variation in the fixing of the coloring agent on the substrate subject of coloring. Therefore, it is considered that these new molecules, comprising a new traditional coloring agent including one or more of the spacer-arms herein defined, as new coloring substances, which in some cases may include properties and degrees of strength which make them different from the coloring agents traditionally used to generate new molecules.

Therefore, new coloring substances are obtained, unknown so far, which are an aspect of this patent. In particular, these new coloring substances are especially useful to dye fibers or fabrics totally or partially made of cotton, regenerated cellulose, polyester, nylon and wool, or else to dye leather, cardboard or paper substrates.

The anionic coloring agents included in this invention are all those habitually used to color these substrates, that is, acid, direct, reactive or disperse coloring agents.

The chromophores of these coloring agents are azo, anthraquinone, formazane, dioxazine, phthalocyanine and/or sulphur.

The corresponding spacer-arm must be included in the molecule of the coloring agent, either by means of a chemical reaction or using an organic intermediary including said spacer-arm for the synthesis of the final coloring agent.

It has been found now, and a is the basis for the present invention, that anionic coloring agents, which comprise at least one spacer arm bound to the structure of said coloring agents, develop new properties and degrees of strength when dyeing different substrates.

Therefore, one embodiment of the invention comprises anionic coloring agents comprising at least a spacer-arm in their chemical structure, wherein said anionic coloring agents have the following formula:
C_{A}—R_{SA}
wherein:
C_{A} is an anionic coloring agent comprising at least a chromophore group selected from the group consisting of azo, anthraquinone, formazane, dioxazine, phthalocyanin and/or sulphur; and
R_{SA} is said spacer-arm, which has the following chemical structure:
—X—R-Z
wherein,
X is a chemical bond or a group having the formula —S(O)ₙ, wherein n is 1 or 2; or a —NR₁-group, wherein R₁ is a hydrogen atom or a linear or branched C₁-C₁₀ alkyl group;
R is a linear or branched C₁-C₁₀ alkylene group;
Z is a —NR₂R₃ group, wherein, R₂ and R₃ are, independently, a hydrogen atom or a linear or branched C₁-C₁₀ alkyl group; or,
Z is a —NR₄— (CH₂)ₘ—W group, wherein, R₄ a hydrogen atom, a linear or branched hydroxy C₁-C₁₀ alkyl group, or a linear or branched C₁-C₁₀ alkyl group;
m is an integer from 1 to 10; and W is a —COOR₅ group, wherein, R₅ is a hydrogen atom or a linear or branched C₁-C₁₀ alkyl group;
or a —CONR₆R₇ group wherein, R₆ and R₇ are, independently, a hydrogen atom or a linear or branched C₁-C₁₀ alkyl group; or a —SO₃H; or —S—SO₃H; or —CN group
or a SO₃R₈ group wherein R₈ a hydrogen atom or a linear or branched C₁-C₁₀ alkyl group
or a —S—SO₃R₉ group, wherein, R₉ is an hydrogen atom, or a linear or branched C₁-C₁₀ alkyl group;
provided that when X is a —NR₁— group, and Z is a —NR₂R₃ group, then R₁, R₂ and R₃ cannot be simultaneously a hydrogen atom.

Moreover, the preferable spacer-arms to change the properties of the coloring agents in question, when they are applied to the substrates above mentioned, are included in the following groups:

a) Spacer-arms having the following chemical structure:
—NY—(CH₂)ₙ—NR₄—(CH₂)₂—W
wherein,
Y is a hydrogen atom, a linear or branched hydroxy C₁-C₁₀ alkyl group, or a linear or branched C₁-C₁₀ alkyl group;
n is an integer from 1 to 10;
R₄ is a hydrogen atom or a linear or branched C₁-C₁₀ alkyl group;
W is a —COOR₅ group, wherein, R₅ is a hydrogen atom or a linear or branched C₁-C₁₀ alkyl group; —CONH₂; —CN; or —SO₃H.

b) Spacer-arms having the following chemical structure:
—NY—(CH₂)₂-Q
wherein,
Y is a hydrogen atom, a linear or branched hydroxy C₁-C₁₀ alkyl group, or a linear or branched C₁-C₁₀ alkyl group; and
Q is a group selected from —S—SO₃R₆, wherein, R₆ is a hydrogen atom, or a linear or branched C₁-C₁₀ alkyl group; and —SO₃R₇, wherein R₇ is a hydrogen atom, or a linear or branched C₁-C₁₀ alkyl group.

The alkyl, hydroxy alkyl and alkylene chains of the spacer-arms can be either straight or branched.

The altered coloring agents which are the object of this patent typically include only one spacer arm, but they can also include two or more, either similar or different spacer-arms.

One aspect of this invention includes coloring compositions, which comprise at least one anionic coloring agent of the formula:
C_{A}—R_{SA}
wherein, C_{A} and R_{SA} are as described above, and an eventual suitable carrier.

Moreover, when even a small amount of coloring agent including a spacer-arm is added to a coloring agent or mixture of coloring agents which does not include said spacer-arms, the properties of the mixture are altered.

In this aspect, it is considered that the coloring agents modified by the inclusion of said spacer-arms behave as catalysts for the fixation reactions of coloring agents which do not comprise said spacer arms.

When dyeing fibers or fabrics totally or partially made of cotton, regenerated cellulose, polyester, nylon and/or wool, or when dyeing leather, cardboard or paper substrates, the spacer-arms mentioned above included in the molecule of each coloring agent typically used in the process involved, can alter some properties of the substrate dyed with the typical coloring agent.

The mentioned change of properties occurs on substrates dyed by the usual traditional procedures. We enclose a few examples of these:

a) Exhaust dyeing with bi-functional reactive dyes:

Dissolve the dye with three parts of hot water. Add the dye to the substrate in water at room temperature. Then execute the following addition program:

5-10 minutes ⅕ salt

5-10 minutes ⅘ salt

20 minutes 2/10 alkali

5-10 minutes start heating

20-30 minutes heat to 60° C.

10 minutes 1/10 alkali

10 minutes 2/10 alkali

10 minutes 5/10 alkali

30-60 minutes fixation time

Salt and alkali quantities

| % of dyestuff | Glauber's Salt g/lt | Soda ash g/lt |
|---|---|---|
| 0.1 | 5-10 | 10-15 |
| 0.5 | 10-25 | 15-20 |
| 1.0 | 15-40 | 20 |
| 2.0 | 35-50 | 20 |
| 3.0 | 40-50 | 20 |
| 5.0 | 50-60 | 20 |

And the properties on cotton may be controlled as follows:

Light: ISO 105-B02 1994

Washing 60° C. ISO 105-C03 1989

Washing 95° C. ISO 105-C04 1989

Perspiration ISO 105-E04 1994

Bleaching:

Hypochlorite ISO 105-N01 1993
Peroxide ISO 105-N02 1993.
   b) Dyeing on leather with 1% dyestuff
   Neutralization: Washed leather is treated during 40 minutes with
   300% water at 35° C.
   1.2% of sodium bicarbonate
   1% of sodium formate
   Final pH must be 4.5-4.8. Drain, wash 10 minutes with water at 50° C.
   Dyeing: set the bath with
   200% water at 50-60° C.
   0.5% dyestuff
   0.5% dispersing agent. Run 30 minutes. Add
   0.5% dyestuff. Run 20 minutes. Add
   0.6% formic acid. Run 20 minutes. Final pH must be 3.8-4.0
   Fat liquor: Set the bath with:
   100% water at 50-60° C. and pH=5
   3% sulfonated leg oil
   2.5% sulfo chlorinated parafine
   0.025% bactericide.
   Run 40 minutes.
   Add 0.5% formic acid.
   Run 20 minutes.
   Add 1% cationic agent.
   Run 15 minutes.
   Dry

c) Dyeing on leather with 0.3% dyestuff and leveling agent.

Neutralization: Similar to previous

Dyeing: Set the bath with

200% water at 50-60° C.

0.5% leveling agent

0.3% dyestuff. Run 40 minutes.

Add 0.3% formic acid.

Run 15 minutes. Final pH must be 3.8-4.0.

Fat liquor: Similar to previous

And the properties on leather may be controlled as follows:

Light fastness: ISO 105-B02 1994

Migration into PVC: ISO 15701 1998

Fastness to water: ISO 11642 1993

Fastness to perspiration ISO 11641 1993

Fastness to washing ISO 1006 UK-LE 1990

The following examples, which are included as an illustration only, show how the present invention can be embodied. The references to parts of components, reactive agents, and the like, correspond to parts in weight.

### EXAMPLE 1

38.3 parts of 2-naphtilamino-3,6,8-trisulfonic (2-naphthylamine-3,6,8-trisulfonic) acid are diazotized as usual, and coupled with 15.2 parts of 3-ureidoaniline previously dissolved in 115 parts of water at 50° C., treated with 30 parts of sodium bicarbonate and ice-cooled at 0-3° C. When the coupling is finished one part of disperser, 140 parts of ice and 19 parts of cyanuric chloride are added, and then stirred for 90 minutes at a pH of 6.5-6.7. Then, the mixture is treated with 18.8 parts of m-phenylendiamine-4-sulfonic acid dissolved in 80 parts of water with sodium hydroxide at a pH of 5.0-7.0, and then ice-cooled at 40° C. The mixture is heated at 35-40° C. and stirred for one hour, maintaining the pH at 6.5-6.7 by adding a 20% solution of sodium carbonate. The monochlorotriazinic dye obtained, is precipitated by adding a solution of sodium chloride 20% w/v. The dye is filtered and the cake is dissolved in 900 parts of water with sodium hydroxide at pH 7. 28.1 parts of 4-aminophenyl-b-hydroxy-ethylsulphone sulfate ester are mixed in 150 parts of water conditioning the pH at 7 with sodium bicarbonate.

To the obtained solution, 13.1 parts of e-aminocaproic acid are added, previously dissolved in 100 ml of water at pH=7.0 with sodium hydroxide 48%. The mixture is heated at 60° C. and mixed within an hour. 22 parts of concentrated hydrochloric acid are added. The obtained suspension is cooled at 0° C. with ice, and the mixture is diazotized with 7 parts of sodium nitrite added as a solution 30% w/w. The mixture is mixed within 1 hour at 0-3° C. and then the excess of nitrous acid is eliminated with sulfamic acid. The diazo obtained is coupled with the foregoing mixture maintaining the pH between 7 and 8 adding a dilute solution of sodium carbonate. The coloring agent obtained is precipitated with potassium chloride, filtered, and dried.

A reactive coloring agent according to formula 1 is obtained.

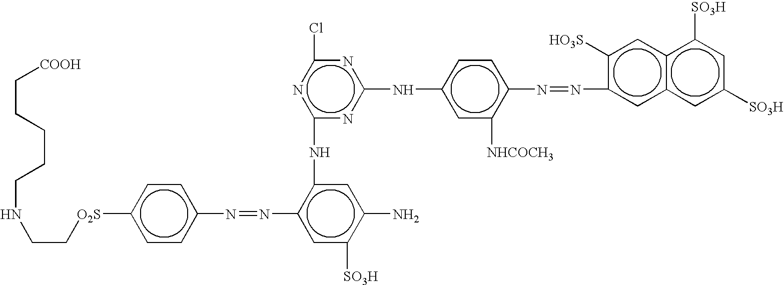

When this new coloring agent is applied on cotton, according to any of the traditional methods, the dyed material obtained exhibits a very good degree of strength and general properties, which may be confirmed by the procedures indicated above.

### EXAMPLE 2

13.1 parts of e-aminocaproic acid are dissolved at a pH 10 in 100 ml of water with sodium hydroxide at 48% and are added on 28.1 parts of 4-aminophenyl-b-hydroxy-ethylsulphone sulfate ester previously dissolved in 150 parts of water at pH 7 with sodium bicarbonate. The mixture is heated at 60° C. and stirred for 1 hour. 22 parts of concentrate hydrochloric acid are added. The obtained suspension is cooled at 0° C. with ice and is diazotized with 7 parts of a solution of sodium nitrite 30%. The mixture is stirred for 1 hour at 0-3° C., and then the excess of nitrous acid is eliminated with sulfamic acid, maintaining the temperature within 0-5° C.

Separately, 31.9 parts of 4-amino-5-hydroxy-2,7-naphthalenedisulfonic acid are dissolved at pH=6.0-6.5 with sodium hydroxide in 100 parts of water, and passed drop wise on a diazo prepared from 26.3 parts of 4,4′-diaminosulfanilide according to the conventional methods.

Finished the above copulation, the resulting compound is coupled with the foregoing diazo raising the pH at 6.0-6.5 with diluted sodium hydroxide. The mixture is stirred for 4 hours. It is stirred for 10-15 minutes. Then, 10.3 parts of m-phenylenediamine are added, and stirred for 1 hour. The obtained product is heated at 80° C. and precipitated with potassium chloride, filtered and dried.

An acid coloring agent according to formula 2 is obtained.

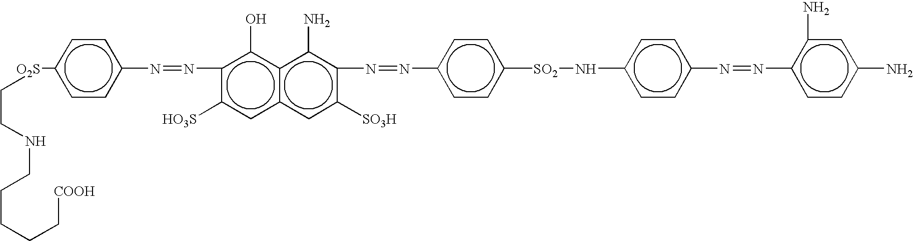

When this new coloring agent is applied on leather, according to any of the traditional methods, the dyed material obtained exhibits a very good degree of strength as well as very good general properties, which may be confirmed by the procedures indicated above.

### EXAMPLE 3

31.9 parts of 4-amino-5-hydroxi-2,7-naphtalenedisulfonic acid are dissolved in 100 parts of water at a pH of 6.0 with diluted sodium hydroxide. 24.3 parts of 4-aminophenyl-N,N-dimethylpropilenediamineethylsulfone are suspended in 100 parts of water, 12 parts of 10 N hydrochloric acid are added. The slurry obtained is then ice-cooled at 0° C., and diazotized with 7 parts of sodium nitrite as a 30% solution. It is stirred for one hour at 0-3° C., and the excessive nitrous acid is eliminated with sulfamic acid. At a constant temperature of 0-5° C. the solution of 4-amino-5-hydroxy-2,7-naphthalenedisulfonic acid is added drop wise on the previous diazo, and stirred for 16 hours. Moreover, 26.3 parts of 4,4′-diaminesulfanilide are diazotized according to conventional methods. The diazo obtained is added rapidly to the previous product after being dissolved with sodium hydroxide diluted at a pH of 6.0-6.5 and ice-cooled at 0-1° C. It is then stirred for 10-15 minutes, and then its pH is adjusted to 9.0 with 10% sodium hydroxide. It is stirred for 4 hours. The product thus obtained is treated with 61.5 parts of Sulphur Black 1 previously reduced in 76 parts of water with 31 parts of sodium hydroxide (48% solution) and 15.6 parts of dextrose for 3-5 hours a 90° C., and ice-cooled at 10° C. The coloring agent thus obtained is precipitated with potassium chloride, then filtered and dried.

A coloring agent according to formula 3 is obtained.

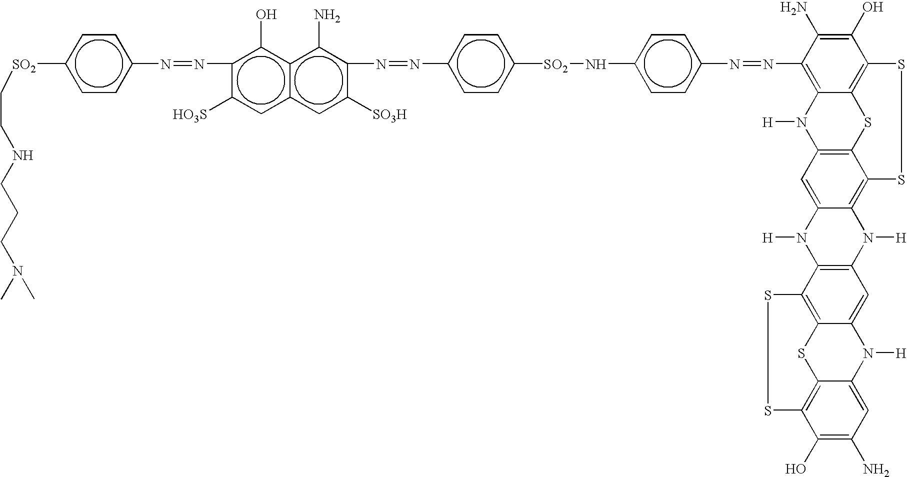

When this new coloring agent is applied on leather, according to any of the traditional methods, the dyed material obtained exhibits a very good degree of strength, as well as very good general properties, which may be confirmed by the procedures indicated above.

### EXAMPLE 4

13.1 parts of ε-aminocaproic acid are dissolved in 100 ml of water at a pH of 10 with 48% sodium hydroxide and added on 39 parts of 4-sulfatoethylsulfonyl-2-aminophenol-5-sulfonic acid previously suspended in 150 parts of water and taken to a pH of 7 with sodium bicarbonate. It is heated to 60° C., and stirred for one hour. 22 parts of concentrated hydrochloric acid are added. The slurry thus obtained is ice-cooled to 0° C., and diazotized with 7 parts of sodium nitrite as a 30% solution. It is stirred for one hour at 0-3° C., and then the excess nitrous acid is eliminated with sulfamic acid. The diazo thus obtained is coupled with 23.9 parts of 6-amino-4-hydroxi-2-naftalenesulfonic (6-amino-4-hydroxy-2-naphthalenesulfonic) acid dissolved in 200 parts of water with 20 parts of sodium carbonate, and ice-cooled to 0° C.; the pH must not be under 7.5. Stirring continues for 2 hours. The pH of the slurry thus obtained is adjusted to 5.5 with a sufficient amount of acetic acid, it is treated with 13.8 parts of chromium acetate, and then heated to boiling point until metallization is complete. The product thus obtained is ice-cooled to 0° C.; 22 parts of hydrochloric acid 10 N are added, and diazotized with 7 parts of sodium nitrite. It is stirred for 60-90 minutes at 0-3° C., and then the excess nitrous acid is eliminated with sulfamic acid. Finally, a solution of 8.85 parts of acetoacetanilide is added together with 5.45 parts of m-aminophenol in 100 parts of water with 4 parts of sodium hydroxide. The pH is adjusted to 9.0-9.5 with 10% sodium hydroxide. The coloring agent thus obtained is precipitated with potassium chloride, then filtered and dried.

A coloring agent according to formula 4 is obtained.

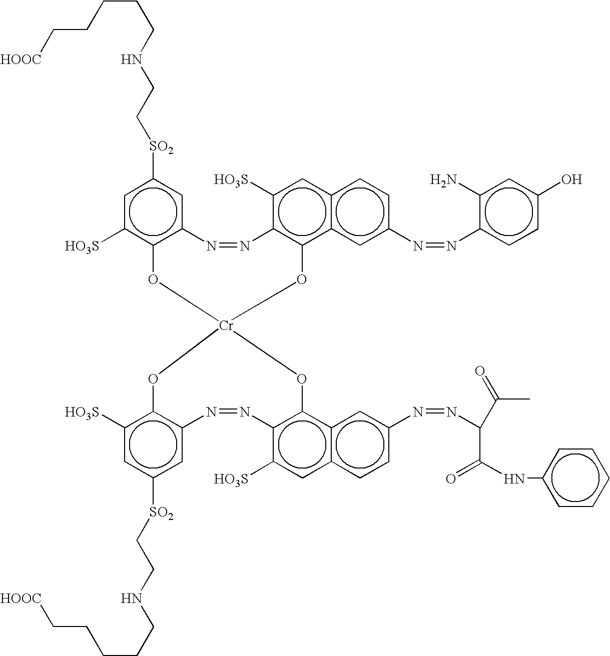

When this new coloring agent is applied on leather, according to any of the traditional methods, the dyed material obtained exhibits a very good degree of strength, as well as very good general properties, which may be confirmed by the procedures indicated above.

### EXAMPLE 5

38.3 parts of 2-naphthylamine-3,6,8-trisulfonic acid are diazotized as usual, and coupled with 15.2 parts of 3-ureidoaniline previously dissolved in 115 parts of water at 50° C., treated with 30 parts of sodium bicarbonate and ice-cooled at 0-3° C. When the coupling is finished one part of disperser, 140 parts of ice and 19 parts of cyanuryl chloride are added, and then stirred for 90 minutes at a pH of 6.5-6.7. Then, the mixture is treated with 18.8 parts of m-phenylendiamine-4-sulfonic acid dissolved in 80 parts of water with sodium hydroxide at a pH of 5.0-7.0, and then ice-cooled at 40° C. The mixture is heated at 35-40° C. and stirred for one hour, maintaining the pH at 6.5-6.7 by adding a 20% solution of sodium carbonate. 11.3 parts of 3-[(2-aminoethyl)amino]propionitrile dissolved in 300 parts of water are added and then heated at 80-85° C. It is stirred for an hour at 80-85° C. The intermediate is then precipitated with hydrochloride acid 10 N at a pH of 1.5 and filtered. The cake is dissolved in 900 parts of water with sodium hydroxide at pH 9 and coupled with 28.2 parts of 4-aminophenyl-[beta]-hydroxy-ethylsulphone sulfate ester diazotized in the usual way. The pH is maintained with a solution of sodium carbonate 20%. The coloring agent obtained is precipitated with potassium chloride and acidifying with hydrochloride acid to pH 1.6, filtered, and resuspended in 760 parts of water, the pH is adjusted to pH 4.7-4.8 with disodium phosphate, and dried.

A reactive coloring agent according to formula 5 is obtained.

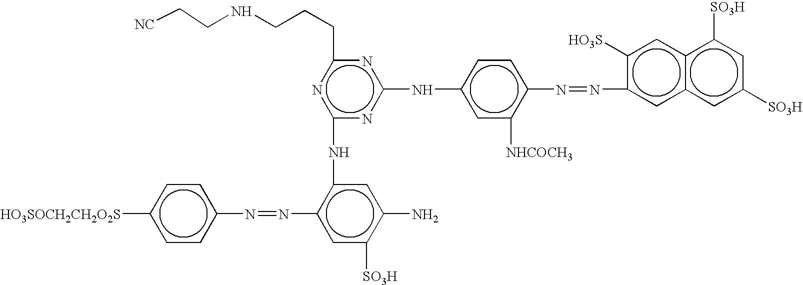

When this new coloring agent is applied on cotton, according to any of the traditional methods, the dyed material obtained exhibits a very good degree of strength and general properties, which is confirmed by the procedures indicated above.

### EXAMPLE 6

38.3 parts of 2-naphthylamine-3,6,8-trisulfonic acid are diazotized as usual, and coupled with 15.2 parts of 3-ureidoaniline previously dissolved in 115 parts of water at 50° C., treated with 30 parts of sodium bicarbonate and ice-cooled at 0-3° C. When the coupling is finished one part of a dispersing agent, i.e. sodium lauryl sulfate, 140 parts of ice and 19 parts of cyanuryl chloride are added, and then stirred for 90 minutes at pH 6.5-6.7. Then, the mixture is treated with 18.8 parts of m-phenylendiamine-4-sulfonic acid dissolved in 80 parts of water with sodium hydroxide at pH 5.0-7.0, and then ice-cooled at 40° C. The mixture is heated at 35-40° C. and stirred for one hour, maintaining the pH at 6.5-6.7 by adding a 20% solution of sodium carbonate. 15.8 parts of 2-aminoethanethiosulfonic acid dissolved in 300 parts of water are added and heated at 80-85° C. and stirred for an hour at 80-85° C. The cake is dissolved in 900 parts of water with sodium hydroxide at pH 9 and coupled with 28.2 parts of 4-aminophenyl-[beta]-hydroxy-ethylsulphone sulfate ester diazotized as usual. The pH is maintained with a 20% solution of sodium carbonate.

The coloring agent obtained is precipitated with potassium chloride acidifying with hydrochloride acid to pH 1.6, filtered, resuspended in 760 parts of water, the pH adjusted to 4.7-4.8 with disodium phosphate, and dried.

A reactive coloring agent according to formula 6 is obtained.

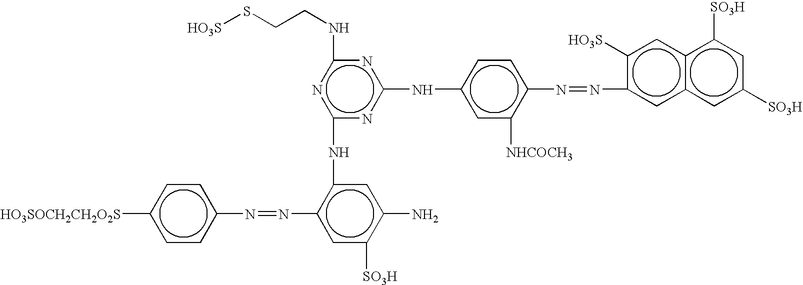

When this new coloring agent is applied on cotton, according to any of the traditional methods, the dyed material obtained exhibits a very good degree of strength and general properties, which may be confirmed by the procedures indicated above

1. An anionic coloring agent comprising an anionic coloring moiety and a spacer-arm of the formula:
C_{A}—R_{SA}
wherein:
C_{A} is an anionic coloring moeity comprising at least a chromophore group selected from the group consisting of azo, anthraquinone, formazane, dioxazine, phthalocyanine and/or sulphur; and
R_{SA} is a spacer-arm of the formula
—X—R-Z
wherein,
X is selected from a chemical bond; a group having the formula —S(O)ₙ, wherein n is 1 or 2; and a —NR₁— group, wherein R₁ is a hydrogen atom or a linear or branched C₁-C₁₀ alkyl group;
R is a linear or branched C₁-C₁₀ alkylene group;
Z is selected from a —NR₂R₃ group, wherein, R₂ and R₃ are, independently, a hydrogen atom or a linear or branched C₁-C₁₀ alkyl group; and
a —NR₄— (CH₂)ₘ—W group,
wherein,
R₄ is a hydrogen atom, a linear or branched hydroxy C₁-C₁₀ alkyl group, or a linear or branched C₁-C₁₀ alkyl group;
m is an integer from 1 to 10; and
W is selected from a —COOR₅ group, wherein, R₅ is a hydrogen atom or a linear or branched C₁-C₁₀ alkyl group; a —CONR₆R₇ group, wherein, R₆ and R₇ are, independently, a hydrogen atom or a linear or branched C₁-C₁₀ alkyl group, —SO₃H; —S—SO₃H; or —CN; a SO₃R₈ group wherein, R₈ is a hydrogen atom or a linear or branched C₁-C₁₀ alkyl group; and a —S—SO₃R₉ group, wherein, R₉ is a hydrogen atom, or a linear or branched C₁-C₁₀ alkyl group;
provided that when X is a —NR₁— group, and Z is a —NR₂R₃ group, then R₁, R₂ and R₃ cannot be simultaneously a hydrogen atom.

2. An anionic coloring agent according to claim 1, wherein the spacer-arm has the formula:
—NY—(CH₂)ₙ—NR₄—(CH₂)₂—W
wherein,
Y is selected from a hydrogen atom; a linear or branched hydroxy C₁-C₁₀ alkyl group; and a linear or branched C₁-C₁₀ alkyl group;
n is an integer from 1 to 10;
R₄ is a hydrogen atom or a linear or branched C₁-C₁₀ alkyl group;
W is a —COOR₅ group, wherein R₅ is a hydrogen atom; a linear or branched C₁-C₁₀ alkyl group; —CONH₂; —CN; or —SO₃H.

3. An anionic coloring agent according to claim 1, wherein said spacer-arm has the following chemical structure:
—NY—(CH₂)₂-Q
wherein,
Y is a hydrogen atom; a linear or branched hydroxy C₁-C₁₀ alkyl group; or a linear or branched C₁-C₁₀ alkyl group; and
Q is a group selected from a —S—SO₃R₆ group wherein R₆ is a hydrogen atom, or a linear or branched C₁-C₁₀ alkyl group; and —SO₃R₇ group wherein R₇ is a hydrogen atom, or a linear or branched C₁-C₁₀ alkyl group.

4. A coloring composition comprising at least one anionic coloring agent according to claim 1 and a suitable carrier.

5. A coloring composition comprising at least one anionic coloring agent according to claim 2 and a suitable carrier.

6. A coloring composition comprising at least one anionic coloring agent according to claim 3 and a suitable carrier.

7. A coloring composition comprising at least two coloring agents, wherein at least one of said coloring agents is an anionic coloring agent according to claim 1.

8. A coloring composition comprising at least two coloring agents, wherein at least one of said coloring agents is an anionic coloring agent according to claim 2.

9. A coloring composition comprising at least two coloring agents, wherein at least one of said coloring agents is an anionic coloring agent according to claim 3.

10. A method for dyeing a substrate comprising applying an anionic coloring agent according to any of claims 1-3 to a substrate selected from the group consisting of fibers, fabrics including cotton, regenerated cellulose, nylon and wool.

11. A method for dyeing a substrate comprising applying an anionic coloring agent according to any of claims 1-3 to a substrate selected from the group consisting of leather, cardboard and paper.

12. A method for dyeing a substrate comprising applying a coloring composition according to claim 4 or 5 to a substrate selected from the group consisting of fibers, fabrics including cotton, regenerated cellulose, nylon, and wool.

13. A method for dyeing a substrate comprising applying a coloring composition according to claim 4 or 5 to a substrate selected from the group consisting of leather, cardboard and paper.

14. A dyed substrate comprising an anionic coloring agent of claim 1 applied to a suitable substrate.

15. A dyed substrate comprising an anionic coloring agent of claim 2 applied to a suitable substrate.

16. A dyed substrate comprising an anionic coloring agent of claim 3 applied to a suitable substrate.

17. A dyed substrate comprising a coloring composition of claim 4 applied to a suitable substrate.

18. A dyed substrate comprising an anionic coloring agent of claim 5 applied to a suitable substrate.

19. A dyed substrate according to any of claims 14-16, wherein the suitable substrate has been dyed by a printing process or any other conventional dyeing technique.

20. A dyed substrate according to claim 17 or 18, wherein the suitable substrate has been dyed by a printing process or any other conventional dyeing technique.
